(19) United States
(12) Patent Application Publication
(10) Pub. No.: US 2002/0013738 A1
(43) Pub. Date: Jan. 31, 2002

(54) Online exhibition center

(76) Inventor: Jan Vistisen, Bissone (CH)

Correspondence Address: John Moetteli, BUGNION S.A., Case Postale 375, Geneva, 1211 GENEVA 12, CH

(21) Appl. No.: 09/874,917

(22) Filed: Jun. 5, 2001

Related U.S. Application Data
(60) Provisional application No. 60/209,239, filed on Jun. 5, 2000.
(60) Provisional application No. 60/229,993, filed on Sep. 5, 2000.

(51) Int. Cl. G06F 17/60

(52) U.S. Cl. 705/26

(57) ABSTRACT

An online exhibition system is provided that overcomes the barriers to establishment of an online exhibition center and enables the online exposition of products and services on the Internet. The system provides a virtual exhibition center that is customized based on the number and nature of the exposition and on the exhibitors themselves. The system creates a clickable floor plan graphic that may be automatically created based on inputs such as the number of participants, the relative size of the participants, the amount of money invested for advertising space, the amount of exhibition space reserved, as well as other factors. Further, participants may bid on the right to place banner advertising as strategic locations on the site. Still further, a highlighting feature is provided that highlights the names of member companies that pay a premium for such service.

### BACKGROUND OF THE INVENTION

This application claims priority to U.S. Provisional Applications 60/209,239 filed Jun. 5^{th}, 2000 and 60/229,993 filed Sep. 5, 2000, the contents of which are hereby incorporated herein by reference thereto.

This invention relates to Internet commerce methods, in particular, to a virtual, Internet-based marketplace, This invention further relates to means of presenting products and services to potential purchasers.

For many years, application of the exposition model has been a means for companies to build awareness among potential customers of the companies' new products and services. The exposition model is a promotional model which provides a physical environment in which companies offering goods and services can present such goods and services to potential user/customers in a context in which the user/consumer is able to benefit from a fuller sensual, interactive experience than simply reading an ad or hearing a radio announcement or even seeing a TV advertisement. Such expositions have heretofore taken place at a physical location in physical structure of some sort and within discrete time periods.

With the advent of the Internet, it is now possible to create a virtual presence on the Internet. For example, a company web site may be created and the potential audience expanded almost limitlessly, due to the lack of real physical limitations such as floor space, etc. Nevertheless, there are peculiarities in presenting expositions that, using the methods currently available, have not yet permitted the reproduction and adaptation of the exposition model to an Internet setting.

In light of the potential benefits, a method and system is needed for providing and managing an Internet-based infrastructure to take advantage of the economies of scale of online business.

### SUMMARY OF THE INVENTION

An online exhibition system is provided that overcomes the barriers to establishment of an online exposition/exhibition center and enables the online exposition of products and services on the Internet. The system provides a virtual exhibition center that is customized based on the number and nature of the exposition and on the exhibitors themselves. For instance, the system creates a clickable floor plan graphic that may be automatically created based on inputs such as the number of participants, the relative size of the participants, the amount of money invested for advertising space, the amount of exhibition space reserved, as well as other factors.

In another feature, participants may bid on the right to place banner advertising at strategic locations on the site.

In another feature, a highlighting feature is provided that highlights the names of member companies that pay a premium for such service.

### BRIEF DESCRIPTION OF THE DRAWINGS

FIG. 1 is a layout/floor plan of the exposition center.

FIG. 2 is a more detailed layout of the exposition center.

FIG. 3 is a schematic diagram of the system of the invention.

FIG. 4 is a user interface for registration of visitors.

FIG. 5 is a user interface for the registration of exhibitors.

FIG. 6 is a user interface for submitting press releases.

FIG. 7 is a user interface for submitting discount offers.

FIG. 8 is a user interface for requesting translations.

FIG. 9 is a user interface permitting exhibitors to place a logo on the site,

FIG. 10 is a user interface allowing exhibitors to bid for their ranking with respect to other advertisers

FIG. 11 is an example of the logo bar display interface.

FIG. 12 is a user interface allowing customization of exhibitor links.

FIG. 13 is a user interface for searching the system for products and/or services.

FIG. 14 is a search results page.

FIG. 15 is a user interface for searching the system for products or services.

FIG. 16 is a user interface that allows exhibitors to place bids for ranking.

FIG. 17 is an administration interface for the bidding associated with the interface of FIG. 16.

### DETAILED DESCRIPTION OF THE PREFERRED EMBODIMENT

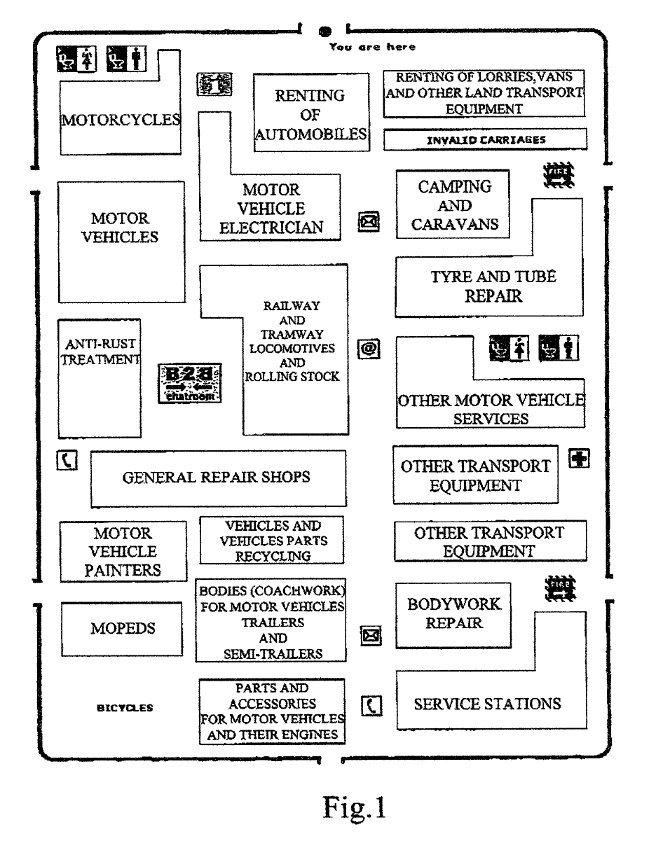

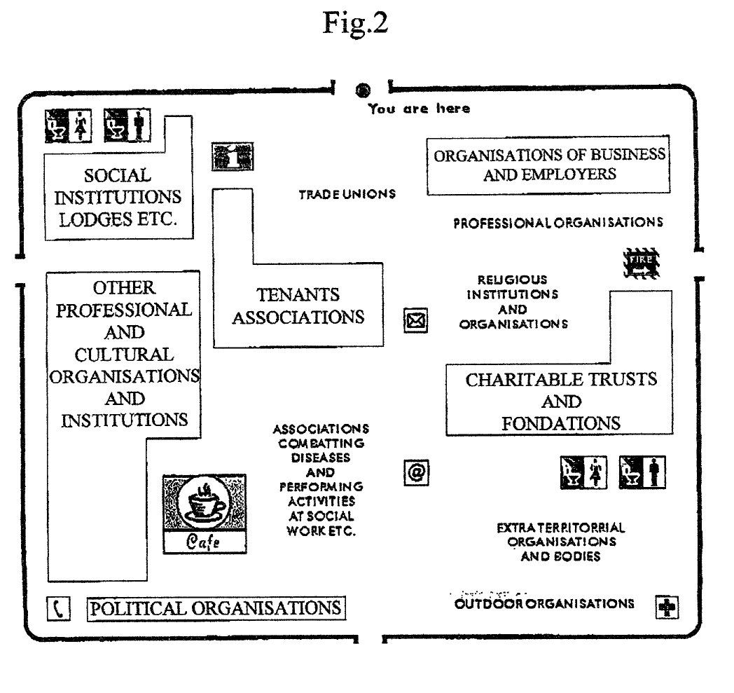

Referring now to FIGS. 1 and 2, an online system is provided that implements a method of hosting an online exposition of products and services. The method comprising the following steps. In a first step, exhibitor data is input. In a second step, exhibitor data is used to create a visual representation of a floor plan of an exposition center. In a third step, exhibitors and visitors are presented with a communication means by which commerce can be facilitated.

In step one, inputs include the contact details of the exhibitor for hypertext linking, the features desired by the Exhibitor, the amount of space required to exhibit, determined, for example based upon the number or products or services offered and the amount of space ordered and paid for, the type of product and/or the category of product. The Exhibitor can choose and pay for a premium location. Premium locations can be distinguished from non-premium locations by the color of the mapped space, animation, such as blinking, of the mapped space, prices which may be offered to those who visit the premium space, each visit automatically generating a prize registration, for example.

In step two, the method takes these inputs or their numerical representations and other inputs such as the total floor space available, the floor space required to separate exhibitor areas (aisles, etc.) and the floor plan of the exhibition space and applies thorn to a formula using these inputs to calculate the size of the Exhibition space relative to the other spaces. A floor plan specialist may then determine location of this space by moving a representation of the calculated floor space around on a layout of the exhibition center. Alternatively, the floor space is determined using templates of floor layouts wherein equal default floor spaces (be they rectangles or other shapes) are multiplied by the relative size factor calculated after comparing the ordered space (either an individual company's ordered space or a summation of all ordered space in an exhibition category) with all spaces ordered by other or by others not in the same category, as the case may be, at any given point in time. This size factor simply graphically expands the template shape for the display category until the total surface area represented equals that ordered or the cumulative space ordered for that category The next template space is then expanded to the appropriate relative size and so on, until all companies or categories have been considered.

In step three, hypertext linking to the exhibitors home page or product page are provided, thus enabling a visitor to communicate with an exhibitor. Other means of communication may be provided as well, such as teleconferencing video conferencing, SMS messaging, chat, or other means. To facilitate communication among exhibitors and visitors, a secure SSL payment page site is provided which, if used, permits the visitor/purchaser to obtain an Exhibition discount and also permits the purveyors of the system to obtain a commission on any sales made through the system.

The system is designed to support standard Internet browsers, such as Microsoft Internet Explorer, versions 3.0-5.5 and Netscape Navigator, versions is. 3.0-6.0.

Setup of Exhibition Center

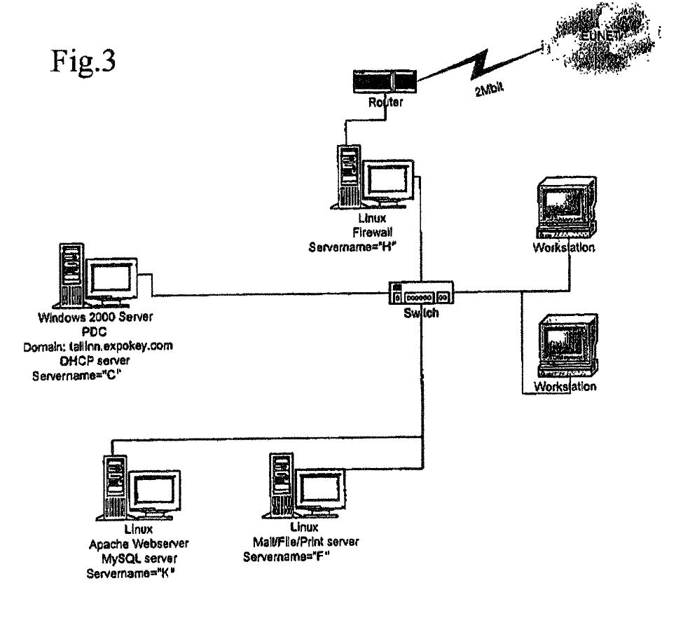

The hardware configuration of the system of the Invention is shown in FIG. 3.

PHP 4 is installed on the server and support for Perl and MySQL is configured. Then the modules DBI.pm and MSQL-MySQL.pm are installed. A Whois subroutine is loaded to detect the visitor origin (country, in order to handle Whois lookups locally on the server.

The system supports web-switch functionality to enable multi server/location setup. This section describes the interactive (not static HTML) functions in the site. Page references refer to enclosure 1, Public Site Structure. Each task (function) is given a unique number, which is used to reference the function.

The virtual exhibition center created by the system includes a variety of fixed exhibitions categorized in accordance with international standards into a number of different subcategories and linking to websites worldwide.

In a feature of the invention, the system further presents exhibitors which a means to bid on the right to place banner advertising, wherein the method includes the additional steps of soliciting bids, evaluating bids to determine a winning bid, informing the winning bid of this fact, inputting banner advertising related graphical and textual information; publishing the banner advertisement in association with the exposition center

User login/registration

The method first prompts the user for username/password when entering restricted areas of expokey.com. Thus, if a user enters restricted area and if name/password has been checked, then the method does nothing. Otherwise, it prompts the user for a username and password or registers a new user.

New visitor registration

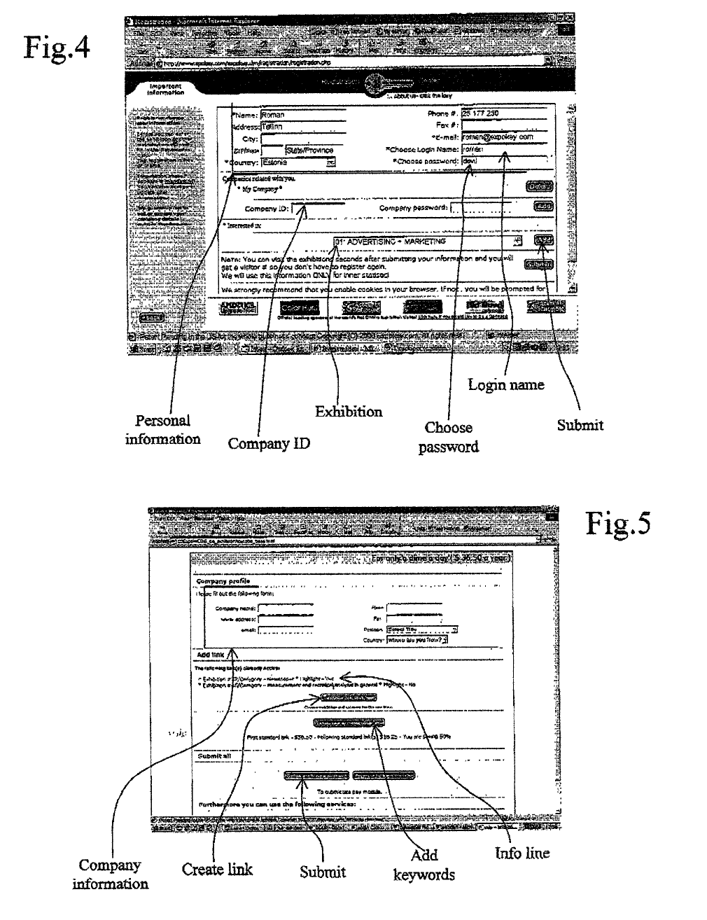

Referring now to FIG. 4 Registration of new visitor, change detail of existing visitors.

Pseudo code:

Determine User ID:

If not registered:

Write information in Personal information fields

Choose password in Password

Choose login name in Login Name

Select necessary Exhibition and Category from Exhibition

(User can add “Info Lines” and delete theme)

Insert company ID in Company ID if want to be related with some registered company

If is registered show user details in necessary fields

Allow him to change information in Personal information, Exhibition, Login

Name and Password fields

Check mandatory fields

If no information do not complete registration

Check new password and login_name with existing in database ones if are similar do not allow registration

Submit all information using button Submit

Write information to Data base

Registration of Companies

Referring now to FIG. 5, registration of the new Exhibitors and adding links.

Pseudo code:

Before opening of page shown in FIG. 5,

If new registration:

Enter information in Company Information

Create new links using Create link page [30] and show them in Info Line

Delete created links if necessary from Info Line

Create additional Keywords for company if necessary

Calculate how much new links and additional keywords are created for determination of price of whole registration

Submit all information using button Submit

Open payment page to complete transaction

Chat

In another feature, Business Chat meeting points (for each exhibition) are provided. These Business Chat meeting points, it is possible to chat online with others either in groups or private. Each exhibition and special show includes a chat meeting room under the name of the exhibition. In each chat room, users, visitors or exhibitors can meet and may be invited to a private room.

The chat function allows visitors and exhibitors to chat on-line. There are two types of chat: exhibition and private. Exhibition chat pages of conventional form are linked to an exhibitions module. The chat feature of the invention allows users to select a privacy option to permits private chat where appropriate.

Webcam Demonstration (online with chat or recorded), Logo Bid Submethod link and virtual shows

The exhibition center runs special shows on minor issues for a specific period, should any organization wish to organize it, i.e. Antique fairs, collectors fairs (matchboxes, cork openers, dolls, special weapons etc., anything which would be of public or private interest, but usually too small to organize in one county alone).

The Visitor Area Access Control:

In one aspect of the invention, an access control method is applied. After a trial period in which access is free, each visitor is only allowed free access to one fixed exhibit, unless a fee is paid for unlimited or semi-limited access. For each visit to a subsequent exhibition, the user incurs a charge per visit, noted by comparing the user id to a matrix of users having access to each fixed exhibit. Any user that does not have an, ID that permits entry is refused entry. Thus, if anyone wishes to avoid payment, they will be required to register under different e-mail addresses when visiting each exhibition and thus have to remember up to 80 different visitor numbers, a significant deterrent to free riding.

Some exhibitions are closed to all but those who have temporal passwords issued by invitation only. Such typical closed exhibits will include weapons and surveillance equipment for police forces Also, individual inventor exhibitors may wish for access to be permitted by invitation only to avoid premature publication of their inventions.

Visiting special events and shows for defined periods are billed separately and are not available free of charge.

The Exhibitor Area Link Quality Control

Broken links are a significant maintenance problem for most web sites. In an embodiment of the method, the method requires linked to merchants or consultants to pay an annual fee for a link to his web page in one or more of the fixed exhibitions of the invention. By charging for the link, it is likely that the link will be maintained and up to date. Thus, visitors do not visit outdated or non-existing companies.

The exhibitor can furthermore choose the following services in order to increase his visibility at the exhibition

Extra keywords, more links, highlighting of name

And Logo Bid Submethod Link direct to homepage (described later)

Or placing adverts in Stock Clearance or the international press center

And run live or rec. demonstrations by web cam

It is useful to locate as many companies for each subgroup as possible and sign them up in order to make the exhibition as international as possible.

Interlinking with related sites wherein an icon placed on a linked-to site points to the exhibition center is contemplated in order to increase visibility. Further, the name of art exhibitor may be enhanced through highlighting (see below, for more detailed description).

The sponsor area

Sponsors of an exhibition can increase the profile of an exhibition as well as that of the sponsors. In a submethod of the invention, the IP number of visitors is checked and the sponsor graphic is displayed according to the location of the login. In this way, if a person is connecting to the site of the invention from the USA—the sponsors and advertisers are American companies.

The International Press Center

In another feature, an International Press Center is provided.

In this area we will run press clips/releases of news from exhibitors under each exhibition.

The center enables any company that is an exhibitor in one or more of the exhibitions enabled by the invention to send a press release regarding the company. This press release will then be published in the press center for a predefined period, say 30 day, after which it is deleted automatically. The press releases may be sent automatically to e-mail addresses of journalists of newspapers in four different groups: Canada and North America, Europe, Asia or the rest of the World.

The press area can also serve as a promotional module for the exhibition center itself. This, together with a Demo-by-web cam, can be very effective. Furthermore, an automated press release distribution module is provided which automatically at periodic intervals, sends media and newspaper journals, via e-mail, the selection of the press releases to send optionally being based on profiles of the journalists gleaned upon registration with the exhibition center.

Read press messages

In the Press Center users can read press messages.

Pseudo code:

Check user data in Registration control before entering

Show press releases from certain Exhibition (number of Exhibition picked up from

Database, User registration table)

Read press releases from database (only up to 30 days old) when necessary exhibition is selected

Write Press Releases on the page [15]

Submit press release

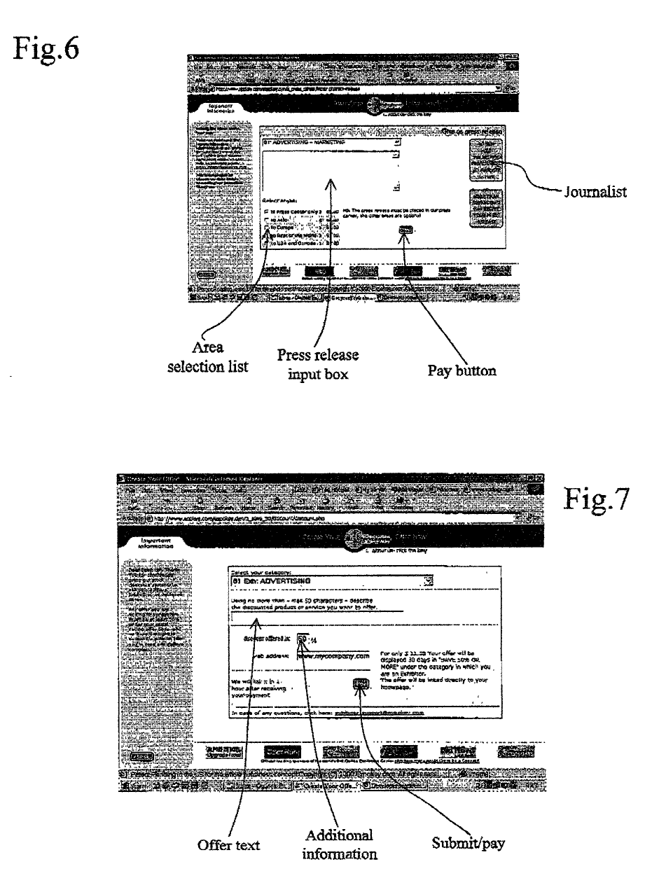

Referring now to FIG. 6, press releases can be submitted by exhibitors.

Pseudo code:

Check User Login and show list of companies

Write press release in press release input box

Select area from area selection list (one or more)

Press center only should not be selectable, as it must be selected.

Press pay button

Or click “Journalist” and go to page to select exhibition, text file and send to journalist of system purveyor to correct it pressing Pay button

Open payment page to complete transaction

Record press release to Database and (if selected) automatically send to recipients (Media) selected in accordance with selected country.

Subscribe press release

Subscription of press releases should only be done by printed or electronic Media.

Pseudo code:

When user presses Subscribe button

If user not registered

Go to user registration page (see FIG. 4)

Else

If user have related companies

Show list of them and show to user selected company details and subscription

Else send to another page to allow him to register new company (Media) and subscribe for press releases (send him Company ID after registration)

Press Release administration

Administration of Press Releases

Pseudo code:

Company send text about company

Message with STATUS as “journalist”

Else (“area”) so STATUS is “released”

Journalist can see all messages with STATUS “journalist”

Save original text to file, change it and send it back to company (STATUS is “company”)

Company receive e-mail with a chanced text and two buttons—submit and change

If agree so ‘submit’ else ‘change’

If ‘submit’ STATUS “released”

Else STATUS “change”

The Stock Clearance Area:

In another feature, a Stock Clearance center is provided. The stock clearance center provides advertising space to announce sale prices of goods offered on clearance.

This submethod allows exhibitors to offer outdated products or overproduction to visitors. The associated module sets up each exhibitor as a hyperlink direct to his homepage in up to 80 main categories

Limitations can be set on the inputs provided by the exhibitor regarding the products or services he sells. For example, the exhibitor may be required to describe his offerings with 10 words, a maximum 50 spaces. When payment is acknowledged as received, the text will then be set as a hyperlink opened to his site.

The term for such sale and link may be dependent on the price paid for such link. After this display period ends, the hyperlink is automatically deleted.

To advertise in Stock Clearance the company must be an exhibitor in the area where the product and services is offered from, furthermore and most important the product or service must be offered for a predetermined percentage discount.

If a visitor notices that the stock is not in fact being offered for the percentage discount indicated, the visitor may complain to the purveyor of the system via a customer service e-mail link or a fill-in form. Such complaints will be followed up in order to ensure visitor interest in the Stock Clearance area.

A quality control function can query the seller for proof to support his claim of the amount of the discount.

In another feature, visitors are queried to ask for a fixed price quote. In this feature, a visitor may ask for a price quote to selected companies in a database having the specific product or service that he is looking for.

Read discount offers

In the “Save50%” page users can read discount offers and add own ones.

Pseudo code:

Check user data in Registration control before entering

Show discount offer from certain Exhibition (no. of Exhibition picked up from Database, User registration table)

Read discount offers from database (only up to 30 days old) when necessary exhibition is selected

Write discount offers to page [16]

Submit discount offer

Referring now to FIG. 7, each Exhibitor can offer their own discounted product or service

Pseudo code:

Before openings show to user pages permitting selection of exhibition

Select Exhibition

Write description of offer into Offer Text

Type necessary text into Additional Information

Submit all information using button Submit/pay

Open payment page to complete transaction

Record data to Data Base also Company ID to determine Name and www of the Company

24 hour Translation Area

In another feature, a 24 hour translation service is provided.

By this service, which may be outsourced, any page, label or screen dump of maximum 300 words can be taxed or e-mailed to a translation module where it is translated to or from one of the Languages used in “welcome” on the opening page of the site of the invention. Translation software available at www.translations.com may be used as well.

This is a paid service in which the client pays according to the pricelist, with his credit card before any translation is done.

In a final step, he can either choose to have the translation taxed or e-mailed back to him within 24 hours.

Translation request

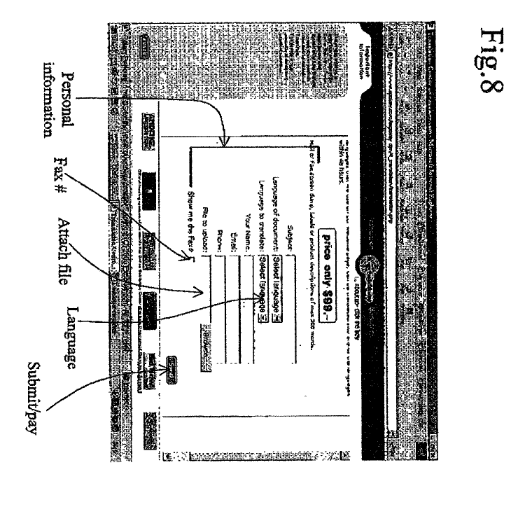

Referring now to FIG. 8, each visitor can send to expokey texts to translate. Write data in Personal Information

Pseudo code:

Upload necessary file using Attach file

Use checkbox Fax# if want to see fax# after payment

Select languages in Language

Submit all information using button Submit/pay

Open payment page to complete transaction

If User want to send text by fax show window with fax number (after payment)

Translation Service administration

Administration of Translation Service

Pseudo code:

See the new inquiries for translation

Click SEND button and send file to necessary translation company (mark languages into Subject field of message)

When operator receive translated text back send to user

Webcam Demonstrations

In another feature, a demonstration by webcam is provided, which optionally may be augmented with online chat or simply be pre-recorded.

In this module, two kinds of services are offered, namely live demonstrations w/online chat and recorded demonstrations. This service allows visitors to the demo-by-web cam to ask questions of the presenters.

A schedule of live demonstrations is posted on the exhibition center in a manner that gives show details for shows to be broadcast within the next thirty-day period.

Equipment suitable to enable the demonstration-by-web cam includes Creative labs Video Blaster Go 640×480/24bit/USB, Kodak DVC323 art 640×480/24bit/USB, Logitech QuickCam Pro 640×480/?bit/USB, sound card, loudspeakers and any microphone The receiver/visitor does not need any web cam. He will however require a sound card, loudspeakers and the necessary bytes available to download the demo on his computer.

The recorded demos can either be made from the best show run from the live demo or an exhibitor can have a ready-made demo. This can be run either as a host or via direct link to the exhibitor's homepage.

The demos are categorized into exhibitions areas as is generally everything else.

Bid for logo/link Submethod

A submethod is provided an which visitors and/or exhibitors can bid to have their logo scanned and displayed in association with a hypertext link direct to their homepage or page of choice These logos may be displayed in the exhibition area and in alphabetic lists.

The submethod is essentially an auction method by which any one who wishes to advertise their logo for a certain period in a specific place on the site can place a bid for such display electronically via a fill in form.

In one step, the interested company must choose any forth-coming month within the next 12 months in which they would like their logo to be displayed. In another step, the bidder must decide where in the exhibition center he would like the logo to be displayed. In another step, the bidder is prompted for the amount they are prepared to pay for having their logo scanned into the areas icons. In within predetermined criteria and identifies the highest bid. In another step, the submethod notifies, via e-mail for example, the highest bidder of his having won the bid and prompts the bidder to pay for such privilege. In another step, after successful payment, the submethod prompts the bidder to forward or e-mail their logo for scanning. In another step, the submethod awaits in input indicating that payment has been received. In another step, if the required payment is received, the submethod retrieves and inserts the logo in the area requested. Otherwise, in another step, if the bidder fails to send money, legal action may be entertained, the next highest bidder will be contacted, and the first bidder will be asked to pay the difference between the bids. This submethod enables flexible pricing depending upon demand in each area.

This submethod can be used for all advertising spaces.

Logo Bid Submethod Link

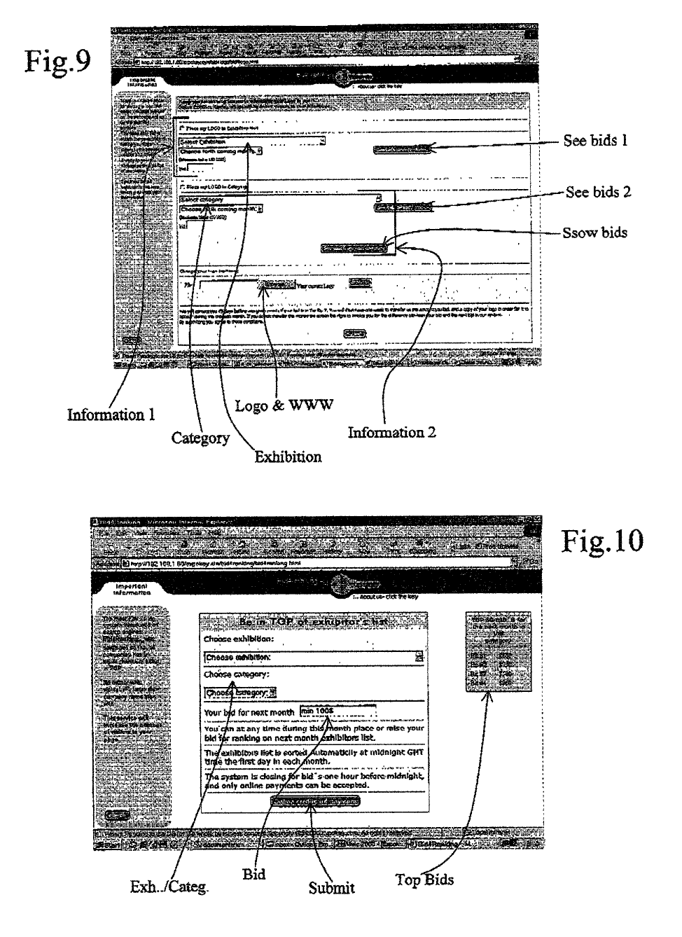

Referring now to FIG. 9, Exhibitors can place their own logo in the online site.

Pseudo code:

Before page opening show pages (select necessary company)

Show registered for this company Exhibitions and Categories ONLY

Write necessary information in Information 1

Select necessary exhibition in Exhibition

See highest bids for this Exhibition using See bids 1 (information picked up from database as statistics)

Category list depends of Exhibition number

Select necessary category in Category

See highest bids for this Category using See bids 2 (information picked up from database)

Enter necessary information in Information 2

Type Company www address and attach Logo picture to Logo & www

See BIDS placed in association with the exhibitors company by Show bids

Submit all information using button Submit/pay

Open payment page to complete transaction

Write all information to Data Base . . .

Ranking Bid Submethod

Referring now to FIG. 10, an interface for placing Bids in the Ranking Bid Submethod is shown.

Pseudo code:

Before opening show pages,

Select Exhibition/Category where to place Bids in Exh/Categ

Place bid in order to Bid

Show biggest bids in that category in TOP bids

Submit all information using button Submit

Write information to Data base

The Virtual Show Area

Demos and exhibitors will produce interactive showrooms where it will be possible to see and to meet them virtually and have the feeling of being on a real exhibition or visiting the company, factory or showroom.

Logo bar in Main Hall

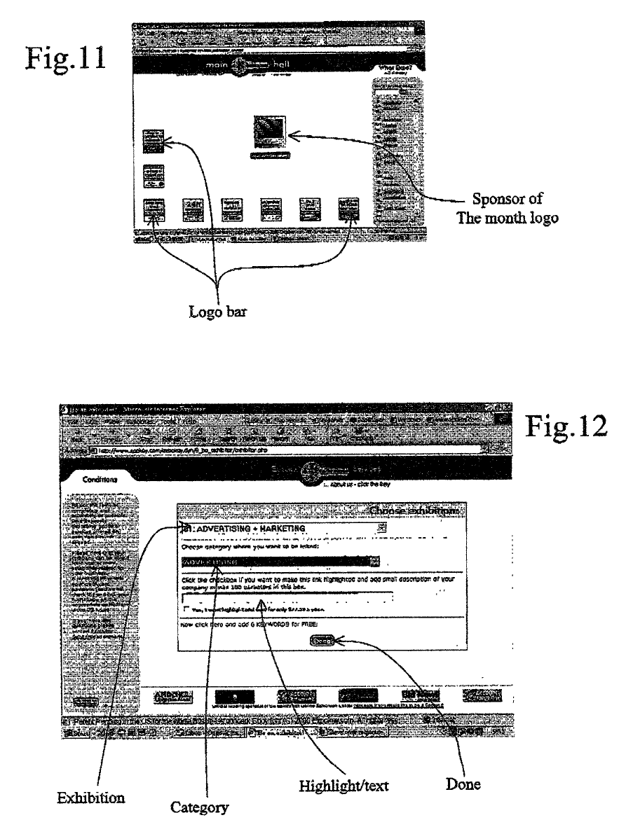

Referring now to FIG. 11, the purpose of the logo bar is to show logos of sponsors (B-Sponsor) specifically for the visitor's country.

Pseudo code:

Identify origin of visitor (country) determined on login location

Fill in 8 sponsor logos for visitor's country, if not—USA sponsors.

Logo bars may also be placed on the index and sub pages

Sponsor of the month logo

The purpose of the logo bar is to show the “Sponsor of the month” (C-Sponsor) logo (see FIG. 11) specific to the visitor's country.

Identify origin of visitor (country) determined on login location. Fill in sponsor of the month logo from visitor's country, if not—USA sponsor.

Creation of links

Referring now to FIG. 12, creation of the links in Categories to Exhibitor's sites.

Pseudo code:

Choose necessary exhibition in Exhibition

Category depends of the number of the selected Exhibition

Choose necessary category in Category

Type text and select checkbox using Highlight if you want to highlight the link

Submit all information using Submit button go to page 31

Information goes to page [13]

Creation of Keywords

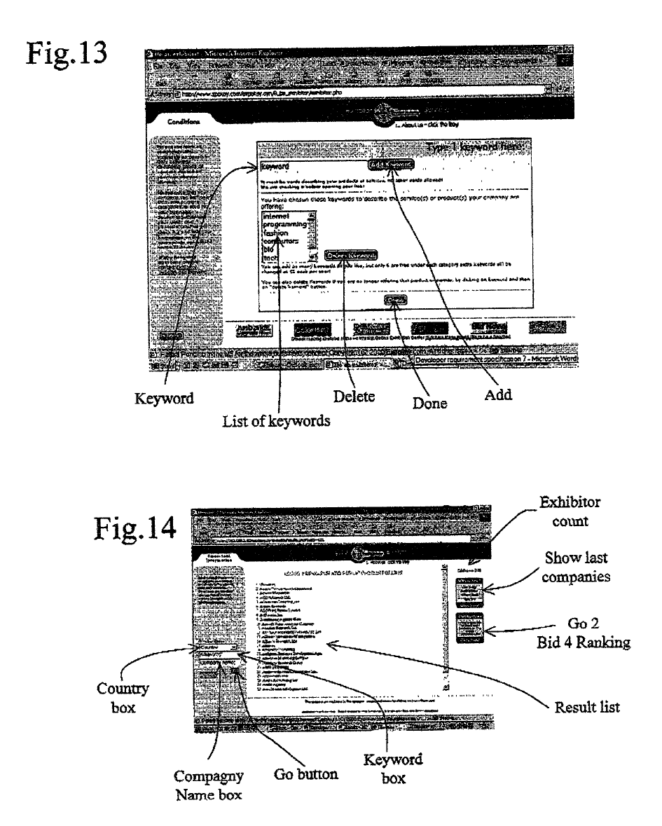

Referring now to FIG. 13, the manner of creating and deleting of Keywords is shown

Pseudo code:

Show all existing Keywords

If user comes from Link Registration page then allow him to add 6 new keywords.

Else if user comes from Registration of Companies page [13] then allow him to add additional Keywords.

Type new keyword in Keyword

Add it to List of Keywords by Add button

Delete if necessary existing keywords from List of Keywords using Delete button

Submit all information by Done button and go to page #13

All information sends to the page #13

Search function

The search function searches for all exhibitors that have keywords that match the given search string.

Pseudo code:

Enter keyword string in Keyword Guide window

Press Go button

Search exhibitor database for Exhibitions with similar keywords (plural and singular form)

Show result list, sorted by Hits

Result page

Referring to FIG. 14, user gets information about companies Filtering is possible by country and/or keyword.

Pseudo code:

Show list of Exhibitors, sorted by “RANK”

Show amount of Exhibitors in Exhibitor count

Select country in country box if necessary

Enter search string in keyword box if necessary

Enter company name in company box if necessary

Press Go button

Search exhibitor database for companies with similar keywords and country and company name.

Show amount of Exhibitors in Exhibitor count

Show list of Exhibitors, sorted by “RANK”

Show list of recently added companies if clicked Show last companies

Comment: Similar means singular/plural of word

Price quote

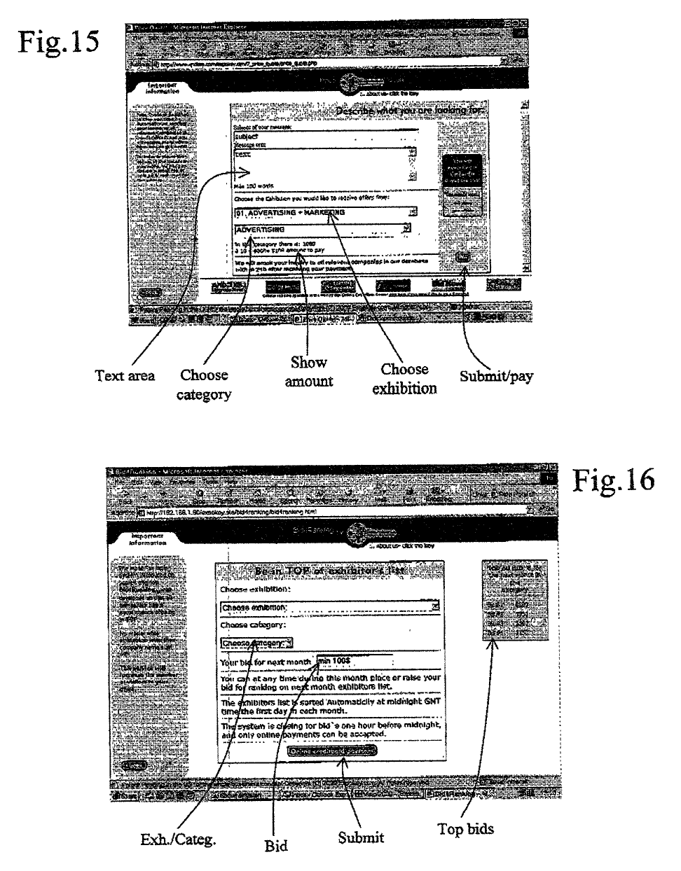

Referring to FIG. 15, user can make an inquiry for searching for some products or services.

Pseudo code:

Check user data in Registration control before entering

Company selection

Pseudo code:

Check automatically User ID and his relations with companies

If no companies, register new one on page [13]

if related with companies, show list of companies and allow modification of details

Ranking Bid Submethod

Referring now to FIG. 16, a Ranking Bid Submethod enables users to place bids for ranking.

Back office functions

Logo Bid Submethod administration

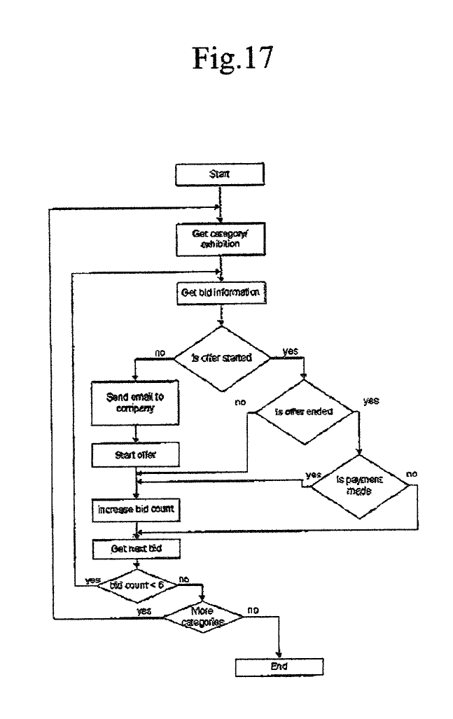

Referring now to FIG. 17, automatic administration of Logo Bid Submethod Link system is shown.

Pseudo code:

Administration system check's highest Bids for the each Exhibition and Category on the First day of the month

Getting top bids for each category/exhibitions

repeat

Check each bid if “offer” is Started . . .

if not then

send email to company

mark “offer” to this bid field ‘started’ with current date

if Yes then

check is offer already ended

if not then

do nothing with bid (this bid might be one of 6)

get next bid

if Yes then

check if payment is made

if Yes then get next bid (this bid is one of 6)

if not then skip this bid

end check offer end

end check offer start

until max 6 bids are ready

Two days before necessary month check Bids for “biddate” and payed

Sponsor Logo administration

Administration of Sponsor Logo system

Pseudo code:

Insert necessary data to “administration” page (company data, logo file, date of placing of logo, type of sponsor, country where to show logo)

Automatic actions for statistics page:

System check's missing logos and logos with expired date for next and after next month for the each Country on the First day of the present month

If logo is missing for next and after next month—place information on to statistics page

if logo is expiring for next and after next month—invite sponsor to renew and place information to statistics page

The system creates an online exhibition center with a variety of fixed exhibitions categorized in accordance with international standards into around 750 different subcategories and linking to websites worldwide.

In an embodiment, the invention includes up to 80 different fixed exhibitions and about 750 different subcategories.

In an advantage of the invention, the exhibition center is an interactive meeting place, thus reducing the amount of travel required to attend fairs and shows.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A computer system that enables a method of hosting an online exposition of products and/or services, the method comprising the steps of;
(a) Inputting exhibitor data;
(b) Using the exhibitor data to create a visual representation of a floor plan of an exposition center; and
(c) Presenting exhibitors and visitors with a communication means by which commerce can be facilitated.

2. A computer system that enables a method of hosting an online exposition of products and/or services, the system providing a means to bid on the right to place banner advertising, wherein the method includes the additional steps of soliciting bids, evaluating bids to determine a winning bid, informing the winning bid of this fact, inputting banner advertising related graphical and textual information; publishing the banner advertisement in association with the exposition center.
